(19) United States
(12) Patent Application Publication
(10) Pub. No.: US 2023/0241577 A1
(43) Pub. Date: Aug. 3, 2023

(54) ACID AND HALIDE REMOVAL FOR AIR CONDITIONING AND REFRIGERATION SYSTEMS

(71) Applicant: Parker-Hannifin Corporation, Cleveland, OH (US)

(72) Inventors: Debasis BANERJEE, Ellisville, MO (US); Eric R. COYLE, Washington, MO (US)

(21) Appl. No.: 18/002,869

(22) PCT Filed: Oct. 14, 2021
(86) PCT No.: PCT/US2021/054895

§ 371 Date: Dec. 22, 2022

Related U.S. Application Data
(60) Provisional application No. 63/092,542, filed on Oct. 16, 2020.

(51) Int. Cl. B01J 20/18; B01J 20/284; B01J 20/28; F25B 43/00

(52) U.S. Cl. CPC B01J 20/18; B01J 20/284; B01J 20/2808; B01J 20/28061; B01J 20/28064; B01J 20/28004; B01J 20/28083; B01J 20/28095; F25B 43/003; B01J 2220/42

(57) ABSTRACT

Described is a filter-drier core for removing acids and halides that are generated by decomposition of a refrigerant that contains a fluoroiodocarbon, the filter drier core comprising a molded core that includes gamma phase activated alumina and a molecular sieve. The molecular sieve has a pore size between 3-4 angstroms and between 300-00 m²/g surface area, and/or the alumina is provided in a beaded form with average bead diameter between 0.1-10 mm. An alumina surface area may be between 140-250 m²/g, and an average pore size may be 6 nm to 16 nm. A percent molecular sieve in the core may be between 0-40%, with the rest of the core being alumina. To increase surface area of the core, the filter-drier core may define a plurality of suitably shaped channels that extend longitudinally through the core, may have fins that extend from a central body, or may be configured as a plurality of rods. A refrigerant system includes a refrigerant circuit through which a refrigerant flows, and a filter-drier unit including the filter-drier core configured for contact with the refrigerant for removing contaminants from the refrigeration system.

### FIELD OF INVENTION

The present application relates generally to removal of toxic contaminant substances, and in particular removal of strong acids and halide ions that are formed because of chemical decomposition of fluoroiodocarbon refrigerants (e.g., CF₃I based refrigerants) used in air conditioning and refrigeration systems.

### BACKGROUND

To combat global warming, there is pressure in various industries to utilize substances that have a low “Global Warming Potential” (GWP), which is a parameter that has been defined as a measure of heat that a greenhouse gas traps in the atmosphere up to a specific time horizon relative to carbon dioxide. It is generally understood that low (<750) GWP refrigerants will mostly be used going forward to combat global warming for residential AC systems. Many new blends and chemistries of new refrigerants are being introduced, which bring challenges and concerns relating to chemical compatibility and long-term performance.

One class of such new refrigerant blends contains fluoroiodocarbon molecules. Fluoroiodocarbon molecules contain carbon-iodine (C−I) bonds, which are much weaker than carbon-fluorine (C—F) bonds of typical fluorocarbon refrigerants, leading to a lower GWP. However, the use of fluoroiodocarbon refrigerant could result in chemical instability in conditions such as, but not limited to, excessive heat, moisture, and light exposure. The breakdown of fluoroiodocarbon type molecules leads to the formation of strong acids and iodide ions. The removal of these harmful components is significant for long-term stability of the refrigerant. Current solutions for removal of acids and iodide from using relatively new fluoroiodocarbon refrigerant blends remain deficient. Although current filter-drier cores are sufficiently designed to remove harmful components for widely adopted fluorocarbon refrigerants, conventional core configurations have proven to be insufficient for use with refrigerants made up with fluoroiodocarbon because of strict restrictions as to how much free iodide can stay out in the solution.

### SUMMARY OF INVENTION

There is a need in the art, therefore, for an enhanced mechanism for removal of strong acids and halide ions (and iodide ions in particular) that are formed because of chemical decomposition of fluoroiodocarbon refrigerant molecules used in newer air conditioning and refrigeration systems, particularly in the presence of excessive temperature and/or moisture or other undesirable environmental conditions. The removal of strong acids and in-situ generated iodide generally is performed using a molded core made of a specific alumina grade and a molecular sieve. The inventors have developed a material solution in the form of a molded drier core with specific binders that enhance removal of the acids and iodide. The molded cores of embodiments of the present application differ from traditional molded cores in being designed to have maximum exposed surface area.

Exemplary embodiments of the present application include a molded drier core that includes gamma phase activated alumina and a molecular sieve. The molecular sieve generally has a pore size between 3-4 angstroms and between 300-800 m²/g surface area. The alumina is provided in a beaded form with average bead diameter between 0.1-10 mm. In exemplary embodiments, core surface area is between 140-250 m²/g, and the average pore size is 6 nm to 16 nm. The percent molecular sieve in the core may be between 0-40%, with the rest of the core being alumina. The kinetics of adsorption of iodide and other related acidic contaminants is the principal basis for optimal adsorption, and the area of exposure for materials to the refrigerant flow is maximized for a given application. Removal kinetics of a contaminant such as iodide from the air-condition and refrigeration system is significant for optimal life of the system. Failure to remove the contaminant fast enough can be detrimental to proper functioning of the system, including the undesirable deposition of metal iodides on the inner surface of copper tubing in the system.

An aspect of the invention, therefore, is a drier core, such as for example a filter-drier core, for removing acids and halides that are generated by decomposition of a refrigerant that contains a fluoroiodocarbon, the drier core comprising a molded core that includes gamma phase activated alumina and a molecular sieve. In exemplary embodiments, the molecular sieve has a pore size between 3-4 angstroms and between 300-800 m²/g surface area, and/or the alumina is provided in a beaded or granular form with average bead diameter between 0.1-10 mm. A core surface area may be between 140-250 m²/g, and an average pore size may be above 6 nm, and more specifically 6 nm to 16 nm. A percent molecular sieve in the core may be between 0-40%, with the rest of the core being alumina. To increase surface area of the core, the drier core may define a plurality of suitably shaped channels that extend longitudinally through the core, or the drier core may have fins that extend from a central body, or the drier core may be configured as a plurality of rods. Another aspect of the invention is a refrigerant system that includes a refrigerant circuit through which a refrigerant flows, and a filter-drier unit including the drier core according to any of the embodiments configured for contact with the refrigerant for removing contaminants from the refrigeration system.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a first configuration of filter-drier core including a plurality of channels with a first cross-sectional shape.

FIG. 2 is a drawing depicting a second configuration of filter-drier core including a plurality of channels with a second cross-sectional shape.

FIG. 3 is a drawing depicting a third configuration of filter-drier core including a plurality of channels with a third cross-sectional shape.

FIG. 4 is a drawing depicting a fourth configuration of filter-drier core including fins that extend from a central body.

FIG. 5 is a drawing depicting a fifth configuration of filter-drier core configured as a plurality of rods.

FIG. 6 is a schematic drawing showing a refrigerant system including a filter-drier unit configured to receive refrigerant.

FIG. 7 is a drawing showing a cross-sectional view of a filter-drier unit in accordance with exemplary embodiments of the present application.

FIG. 8 is a graphical depiction of exemplary iodide removal kinetics of the filter drier cores of the current application.

FIG. 9 is a graphical depiction of exemplary iodide removal kinetics for high-capacity applications of the filter drier cores of the current application.

### DETAILED DESCRIPTION

Embodiments of the present application will now be described with reference to the drawings, wherein like reference numerals are used to refer to like elements throughout. It will be understood that the figures are not necessarily to scale.

Embodiments of the present application provide for an enhanced mechanism for removal of strong acids and halide ions (and iodide ions in particular) that are formed because of chemical decomposition of fluoroiodocarbon refrigerant molecules used in newer air conditioning and refrigeration systems, particularly in the presence of excessive temperature and/or moisture or other undesirable environmental conditions. The removal of strong acids and in-situ generated iodide generally is performed using a molded core made of a specific alumina grade and a molecular sieve. The inventors have developed a material solution in the form of a molded drier core with specific binders that enhance removal of the acids and iodide. The molded drier cores of embodiments of the present application differ from traditional molded cores in being designed to have maximum exposed surface area.

Exemplary embodiments include a molded drier core that includes gamma phase activated alumina and a molecular sieve. Gamma phase activated alumina is determined by the inventors to be a superior core material as compared to conventional filter drier core materials. Gamma phase activated alumina has more active sites as compared to other phases of activated alumina, such as for example bohemite phase alumina, and thus the gamma phase activated alumina exhibits more adsorption behavior under similar experimental conditions. Gamma phase activated alumina also exhibits superior chemical compatibility over other forms of alumina-based materials, such as for example metal impregnated alumina.

More specifically, porous alumina materials, also referred to as activated alumina, are derived from aluminum hydrates such as boehmite, bayerite, and gibbsite, or from other proprietary chemical methods. Based on the chemical nature of the initial aluminum hydrates, heat treatment leads to different phases of alumina by means of removal of surface and chemically bound water molecules, i.e. dehydration, and by dehydroxilation (—OH group removal). The different phases include γ (gamma), η (eta), δ (delta), and θ (theta) phases, and there are others. The main difference among these phases is the amount of water and hydroxy groups left with associated crystal structure changes. For example, boehmite has an orthorhombic crystal structure, while 6-alumina has a defect spinel, cubic crystal structure. Similarly, bayerite has a monoclinic crystal structure, while heated bayerite, namely η-phase, has a cubic crystal form.

The use of activated γ-alumina (gamma alumina) is demonstrated by the inventors to have significant advantages in the context of drier core structures as compared to alternative phases. The number of Lewis acidic sites in the form of aluminum metal center, and Lewis basic sites in the form of —OH and -oxide groups, is significantly higher than boehmite based activated alumina of other phases. These Lewis acidic and basic sites can adsorb inorganic anions such as F⁻ and acid ions such as H⁺ in an efficient manner. While further heating generally results in more creation of Lewis acidic and basic sites by means of removal of water molecules, this requires even further heating which for large scale manufacturing can be cost prohibitive, which renders the higher number of Lewis acidic and basic sites of activated γ-alumina advantageous as compared to alternative alumina phases. Furthermore, γ-alumina is found to have excellent capacity for adsorbing anions like iodide and acid molecules. The beaded or granular version of γ-alumina can be made, for example, by heating the boehmite form of alumina, or by heating powder of boehmite alumina to the γ-form and then agglomerating the alumina.

The molecular sieve generally has a pore size between 3-4 angstroms and between 300-800 m²/g surface area. The alumina is provided in a beaded or granular form with average bead diameter between 0.1-10 mm. In exemplary embodiments, alumina surface area is between 140-250 m²/g, and the average pore size is above 6 nm, and more specifically 6 nm to 16 nm. The percent molecular sieve in the core may be between 0-40%, with the rest of the core being alumina. The kinetics of adsorption of iodide and other related acidic contaminants is the principal basis for optimal performance, including faster removal of acid and iodide from the solution, and the area of exposure for materials to the refrigerant flow is maximized for a given application.

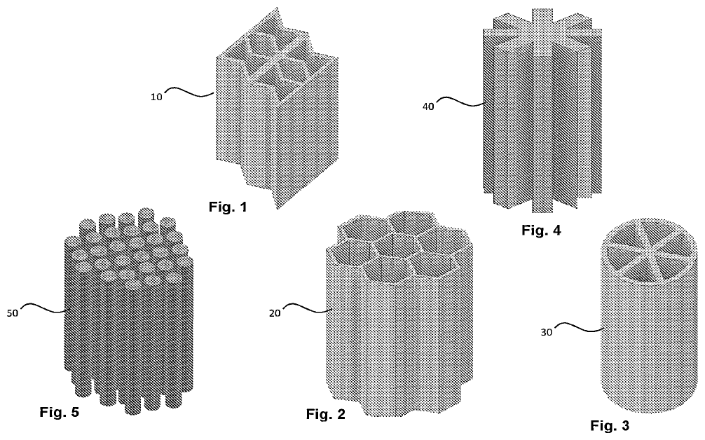

FIGS. 1-5 depict several exemplary designs or configurations of drier cores, such as for example filter-drier cores, to maximize the surface area of the core. It will be appreciated that these examples are non-limiting. In exemplary embodiments, the drier core enhances surface area by defining a plurality of channels that extend longitudinally through the core. For example, FIG. 1 illustrates an example of a filter-drier core 10 having a regular pattern of alternating diamond and hourglass channels that extend longitudinally through the core. FIG. 2 illustrates an example of a filter-drier core 20 having a regular pattern of hexagonal channels that extend longitudinally through the core. FIG. 3 illustrates an example of a filter-drier core 30 having a regular pattern of triangular channels that extend longitudinally through the core. Other regular or irregular patterns of longitudinal channels may be employed to enhance core surface area and being shaped to accommodate a particular implementation.

In exemplary embodiments, the drier core enhances surface area by enhancing the outer surface area of the core. For example, FIG. 4 illustrates an example of a filter-drier core 40 having a regular pattern of fins that extend from a central body. FIG. 5 illustrates an example of a filter-drier core 50 configured as a plurality of rods, with the surface area being enhanced as the outer surfaces of the individual rods. Other regular or irregular patterns of external or outer surface areas may be employed to enhance core surface area and being shaped to accommodate a particular implementation.

To enhance performance, additional component materials may be added to the core material. Typical refrigerants can have stability issues at high temperature, and to reduce refrigerant breakdown various additives may be employed. In the context of the drier cores of the current application, an issue may arise in that certain conventional stability additives may be adsorbed into the core materials including the alumina. In exemplary embodiments, the core material may be enhanced by preloading alumina with an additive adsorption blocker, such as for example oil, to block the adsorption of additives in the core, and particularly block the adsorption of refrigerant additives within the alumina core material.

More specifically, blocking the pore surface of alumina with an additive adsorption blocker enhances the capability of the alumina to adsorb acid and iodide, by means of the size exclusion principle. Given the smaller kinetic diameter of mineral acid and iodide, the adsorption kinetics of these molecular is not likely to be hampered, while additives with much larger kinetic diameter will be severely restricted. Often system additives otherwise get adsorbed into the alumina core material with possible decomposition of the additive, which leads to multiple challenges such as loss of additive function and loss of acid/iodide capacity for the filter core material. To prevent functional loss, the filter core material may be preloaded with a liquid hydrocarbon, or a refrigerant oil such as polyolester oil (POE), that acts as an additive adsorption blocker. The liquid hydrocarbon should be miscible with refrigerant system oil such as POE. Examples of such liquid hydrocarbons include hexane, heptane, and other members of aliphatic/aromatic hydrocarbon families whose molecular size and shape is commensurate with the pore size, shape, and volume of the target alumina. Given similar interaction between a refrigerant additive and the alumina as with interaction between a liquid hydrocarbon and alumina, but stronger interaction between the acid and the alumina, the additive will not be adsorbed or a slowdown in additive adsorption occurs, which is beneficial for system performance and long-term system health. In addition to hydrocarbons, other liquid chemicals may be used that have miscibility with refrigerant and system oil and do not clog expansion devices installed in the system. When small chain hydrocarbon is used as the additive adsorption blocker, the percent used is well below the standard LFL (lower flammability level) for that particular hydrocarbon, and the liquid chemicals should be compatible with all system components. Various chemicals with the above properties may be used with the core elements that are described.

An alternative strategy is to use gamma phase activated alumina materials that have a tailored pore size. Given the smaller size of iodide and acid ions, molecules can preferentially adsorb those over the additive molecules which tend to be larger in terms of their kinetic diameters. While alumina material does not have a tight pore size distribution as compared to molecular sieve materials, the pore size distribution can be tailored towards a lower end of 6 nm if needed by carefully controlling the calcination temperature and time. For example, the additive blocking alumina material can have an average pore size of 6 nm to 16 nm.

In other exemplary embodiments, the drier core material may include a color changing indicator, such as phenolphthalein, that is added to the alumina to indicate when the core is saturated with acid molecules and a new filter is needed. The filter adsorbs acid and iodide and has a finite total capacity. An indicator or solution that indicates the end of life or saturation point in terms of acid and iodide adsorption by the filter material is an effective way to enhance the system longevity. Given the generation of acid in in the system, a pH indicator loaded into the γ-alumina can be used to depict the end of life for the filter. pH indicators include halochromic chemical compounds that are used for visual measurement of pH of a solution. Given the non-aqueous nature of the refrigerant, pH indicators can be directly sprayed on the γ-alumina material. The pH indicator mostly interacts with the surface basic OH group of the alumina, showing color in the basic regime. As the filter adsorbs acid molecules during the system operation, once all the binding sites on the alumina material in the filter core material are consumed, the excess H⁺/H₃O⁺ will interact with the indicator changing the color toward the acidic regime. This will indicate that the capacity of the filter is exhausted and there is a need to change the filter. As the core solution is expected to be inside a hard shell within the system, a circular or other shaped high-pressure glass window may be installed on the shell for visualization of the indicator.

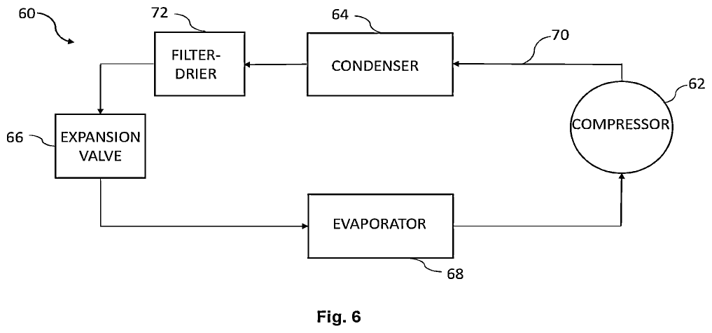

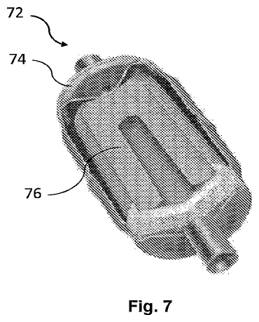

The filter-drier core configurations as depicted in any of FIGS. 1-5 and 7 may be employed, for example, in air-conditioning, heat pump, and refrigeration system applications, and particularly to a filter-drier unit. The configurations and variations described above also can be used in the oil line of a VRF (variable refrigerant flow) or VRV (variable refrigerant volume) system in the form of a filter drier unit. Referring to FIG. 6, a schematic drawing of an exemplary refrigeration system 60 is shown. The exemplary refrigeration system 60 includes a refrigerant circuit having a compressor 62, a condenser 64, an expansion valve 66, and an evaporator 68 that are arranged along a refrigerant fluid conduit loop 70. During normal operation, a refrigerant flows continuously along the refrigerant fluid conduit loop 70. The refrigeration system 60 further includes a filter-drier unit 72 through which the refrigerant passes. The filter-drier unit 72 may be arranged downstream of the condenser 64 along the refrigerant fluid conduit loop 70 for receiving compressed air. In other exemplary applications, the filter-drier unit 72 may be suitable for use along other portions of the refrigerant fluid conduit loop 70.

FIG. 7 is a drawing showing a cross-sectional view of the filter-drier unit 72 in accordance with exemplary embodiments of the present application. The filter-drier unit 72 includes an exterior housing 74 that is formed of a hard material, such as any suitable metal or rigid plastic material as are used in the art. The exterior housing 74 supports a filter-drier core material 76 configured for contact with the refrigerant for removing contaminants from the refrigeration system, such as moisture which may cause freezing and corrosion of components within the refrigeration system 70, or react with lubricants of the system to form undesirable organic acids that may adversely affect operation of the components. The filter-drier unit 72 is effectively used for drying the refrigerant. The core material 76 may be configured as a gamma phase activated alumina core as described above and may be shaped and configured in accordance with any of the embodiments of FIGS. 1-5.

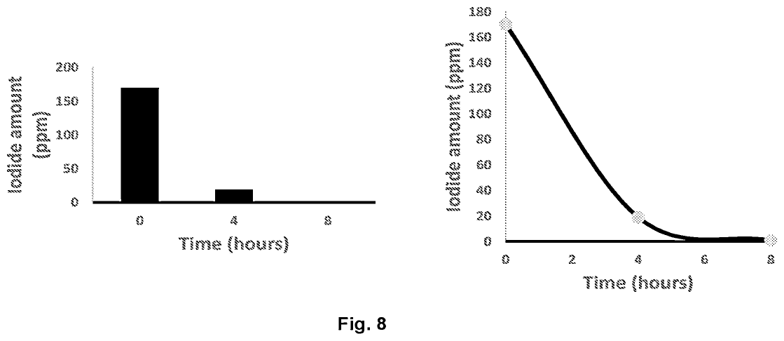

FIG. 8 is a graphical depiction of exemplary iodide removal kinetics of the filter drier cores of the current application. In particular, FIG. 8 illustrates the iodide amount in parts per million versus time that can be achieved using the filter drier core configurations of the current application. The left portion of FIG. 8 has a bar graph format, and the right portion of FIG. 8 illustrates comparable results in a line graph format. In the example of FIG. 8, a starting iodide amount is 180 ppm, and such starting amount of 180 ppm of iodide falls to 19 ppm of iodide in approximately four hours, and the iodide amount goes below the detection limit in approximately eight hours. Such results provide enhanced iodide elimination as compared to conventional configurations.

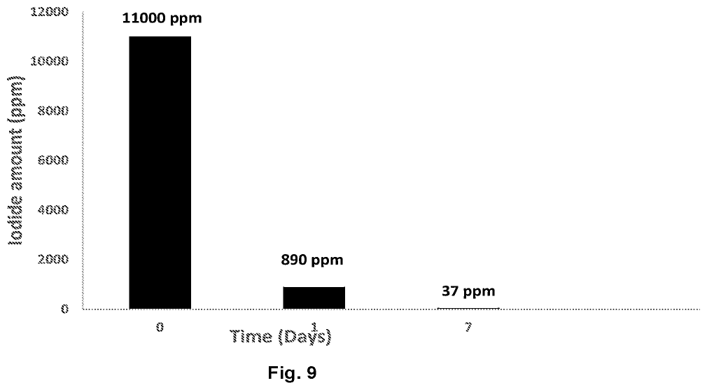

FIG. 9 is a graphical depiction of exemplary iodide removal kinetics for high-capacity applications of the filter drier cores of the current application. Similarly as in FIG. 8, FIG. 9 illustrates the iodide amount in parts per million versus time that can be achieved using the filter drier core configurations of the current application. In the example of FIG. 9, a high-capacity application is illustrated and thus a starting iodide amount is 11000 ppm. Such starting amount of 11000 ppm of iodide falls to 890 ppm of iodide in approximately one day, and the iodide amount falls to 37 ppm in seven days. Accordingly, the results show over 90% of the iodide reduction within just one day under high-capacity circumstances. Such results also provide enhanced iodide elimination as compared to conventional configurations.

An aspect of the invention, therefore, is a drier core, such as for example a filter-drier core, for removing acids and halides that are generated by decomposition of a refrigerant that contains a fluoroiodocarbon, the drier core comprising a molded core that includes gamma phase activated alumina and a molecular sieve. In exemplary embodiments, the molecular sieve has a pore size between 3-4 angstroms and between 300-800 m²/g surface area, and/or the alumina is provided in a beaded form with average bead diameter between 0.1-10 mm. The alumina surface area may be between 140-250 m²/g, and an average pore size may be above 6 nm, and more specifically 6 nm to 16 nm. A percent molecular sieve in the core may be between 0-40%, with the rest being alumina. To increase surface area of the core, the filter-drier core may define a plurality of suitably shaped channels that extend longitudinally through the core, or the filter-drier core may have fins that extend from a central body, or the filter-drier core may be configured as a plurality of rods. The filter-drier core further may include an additive adsorption blocker, such as oil, to block the adsorption of refrigerant additives within the alumina core, and/or a color changing indicator to indicate when the acid adsorption reaches saturation in the core.

Another aspect of the invention is a refrigerant system including a refrigerant circuit through which a refrigerant flows, and a filter-drier unit including a drier core according to any of the embodiments configured for contact with the refrigerant for removing contaminants from the refrigeration system. In exemplary embodiments, the filter-drier unit may include an exterior housing that supports the drier core. The refrigerant circuit may include a compressor, a condenser, an expansion valve, and an evaporator that are arranged along a refrigerant fluid conduit loop through which the refrigerant flows, and the filter-drier unit may be arranged downstream of the condenser along the refrigerant fluid conduit loop.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A drier core for removing acids and halides that are generated by decomposition of a refrigerant that contains a fluoroiodocarbon, the drier core comprising a molded core that includes gamma phase activated alumina and a molecular sieve.

2. The drier core of claim 1, wherein the molecular sieve has a pore size between 3-4 angstroms and between 300-800 m²/g surface area.

3. The drier core of claim 1, wherein the alumina is provided in a beaded or granular form with average bead diameter of 0.1-10 mm.

4. The drier core of claim 1, wherein a core surface area is between 140-250 m²/g, and an average pore size is 6 nm to 16 nm.

5. The drier core of claim 1, wherein a percent molecular sieve in the core is between 0-40%, with the rest of the core being alumina.

6. The drier core of claim 1, wherein the core defines a plurality of channels that extend longitudinally through the core.

7. The drier core of claim 6, wherein the plurality of channels is configured in a regular pattern.

8. The drier core of claim 7, wherein the regular pattern is one of alternating diamond and hourglass channels, hexagonal channels, or triangular channels.

9. The drier core of claim 1, wherein the filter-drier core has fins that extend from a central body.

10. The drier core of claim 1, wherein the filter-drier core is configured as a plurality of rods.

11. The drier core of claim 1, wherein the filter-drier core includes an additive adsorption blocker to block the adsorption of refrigerant additives by the alumina core.

12. The drier core of claim 11, wherein the additive adsorption blocker is an oil.

13. The drier core of claim 11, wherein the additive adsorption blocker is a liquid hydrocarbon.

14. The drier core f claim 11, where the additive adsorption blocker is the gamma phase alumina with an average pore size of 6 nm to 16 nm.

15. The drier core of claim 1, wherein the filter-drier core includes a color changing indicator to indicate when acid adsorption reaches saturation in the filter-drier core.

16. The drier core of claim 15, wherein the color changing indicator is a pH indicator directly sprayed on the gamma phase activated alumina.

17. A refrigerant system comprising:
a refrigerant circuit through which a refrigerant flows; and
a filter-drier unit including a drier core according to claim 1 configured for contact with the refrigerant for removing contaminants from the refrigeration system.

18. The refrigerant system of claim 17, wherein the filter-drier unit includes an exterior housing that supports the drier core.

19. The refrigerant system of claim 17, wherein the refrigerant circuit includes a compressor, a condenser, an expansion valve, and an evaporator that are arranged along a refrigerant fluid conduit loop through which the refrigerant flows.

20. The refrigerant system of claim 19, wherein the filter-drier unit is arranged downstream of the condenser along the refrigerant fluid conduit loop.
